(19) United States
(12) Patent Application Publication
(10) Pub. No.: US 2026/0252248 A1
(43) Pub. Date: Aug. 27, 2026

(54) SELF-TUNING FOR REFRESH RATES IN A HIGH-BANDWIDTH MEMORY DEVICE

(71) Applicant: Micron Technology, Inc., Boise, ID (US)

(72) Inventors: Bokuba Nwengela, El Dorado Hills, CA (US); Raymond Chang, Sacramento, CA (US); Raghukiran Sreeramaneni, Frisco, TX (US); Nevil N. Gajera, Meridian, ID (US); Yasir Husain, Folsom, CA (US)

(21) Appl. No.: 19/459,892

(22) Filed: Jan. 26, 2026

Related U.S. Application Data
(60) Provisional application No. 63/763,242, filed on Feb. 25, 2025.

(51) Int. Cl. G06F 3/06; G01K 13/00

(52) U.S. Cl. CPC G06F 3/0634; G01K 13/00; G06F 3/0626; G06F 3/0659; G06F 3/0673

(57) ABSTRACT

Systems, devices, and methods for self-tuning high-bandwidth memory (HBM) devices for refresh rates are disclosed herein. In some embodiments, an HBM device includes memory dies and through-silicon vias. Each memory die can include memory cells, a temperature sensor, and a refresh rate adjustment circuit. The refresh rate adjustment circuit can be operably coupled to the memory cells and the temperature sensor, and can be configured to (i) receive a current temperature reading from the temperature sensor, (ii) receive an accumulated temperature signal characterizing temperatures of other memory dies, (iii) identify a maximum temperature, (iv) determine a scaling factor for the respective memory die, (v) receive a set of refresh commands from a host device, and (vi) filter the set of refresh commands by selectively discarding one or more refresh commands based at least in part on the determined scaling factor.

### CROSS-REFERENCE TO RELATED APPLICATION(S)

The present application claims priority to U.S. Provisional Patent Application No. 63/763,242, filed February 25, 2025, the disclosure of which is incorporated herein by reference in its entirety.

### TECHNICAL FIELD

The present technology generally relates to vertically stacked semiconductor memory devices and, more specifically, to systems and methods for self-tuning for refresh rates within high-bandwidth memory devices of a system-in-package.

### BACKGROUND

An electronic apparatus (e.g., a processor, a memory device, a memory system, or a combination thereof) can include one or more semiconductor circuits configured to store and/or process information. For example, the apparatus can include a memory device, such as a volatile memory device, a non-volatile memory device, or a combination device. Memory devices, such as dynamic random-access memory (DRAM) and/or high-bandwidth memory (HBM), can utilize electrical energy to store and access data.

With technological advancements in embedded systems and increasing applications, the market is continuously looking for faster, more efficient, and smaller devices. To meet market demands, semiconductor devices are being pushed to the limit with various improvements. Improving devices, generally, may include increasing circuit density, increasing circuit capacity, increasing operating speeds (or otherwise reducing operational latency), increasing reliability, increasing data retention, reducing power consumption, or reducing manufacturing costs, among other metrics. Attempts, however, to meet market demands, such as by reducing the overall device footprint, can often introduce challenges in other aspects, such as maintaining circuit robustness and/or failure detectability.

### BRIEF DESCRIPTION OF THE DRAWINGS

FIG. 1 is a partially schematic cross-sectional diagram of a system-in-package device.

FIG. 2 is a partially schematic cross-sectional diagram of a system-in-package device configured in accordance with some embodiments of the present technology.

FIG. 3 is a partially schematic cross-sectional diagram of a high-bandwidth memory (HBM) device configured in accordance with some embodiments of the present technology.

FIG. 4 is a flowchart illustrating a method for adjusting a refresh rate of a memory die in a stack of memory dies in accordance with some embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

High data reliability, high speed of memory access, lower power consumption, and reduced chip size are features that are demanded from semiconductor memory. In recent years, vertically stacked memory devices have been introduced, often referred to as 2.5-dimensional (“2.5D”) memory devices when placed adjacent to a host device, and 3-dimensional (“3D”) memory devices when stacked above a host device. Some 2.5D and 3D memory devices are formed by stacking memory dies vertically and interconnecting the dies using through-silicon (or through-substrate) vias (TSVs). Benefits of the 2.5D and 3D memory devices include shorter interconnects (which reduce circuit delays and power consumption), a large number of vertical vias between layers (which allow wide bandwidth buses between functional blocks, such as memory dies, in different layers), and a considerably smaller footprint. Thus, the 2.5D and 3D memory devices contribute to higher memory access speed, lower power consumption, and chip size reduction. Example 2.5D and 3D memory devices include Hybrid Memory Cube (HMC) and High-Bandwidth Memory (HBM) devices. For example, HBM devices are a type of memory that includes a vertical stack of dynamic random-access memory (DRAM) dies and, optionally, an interface die (which, e.g., provides the interface between the DRAM dies of the HBM device and a host device).

In a system-in-package (SiP) configuration, HBM devices may be integrated with a host device (e.g., a graphics processing unit (GPU), a computer processing unit (CPU), a tensor processing unit (TCU), and/or any other suitable processing unit) allowing communication therebetween. Because traffic between the HBM devices and host device resides within the SiP (e.g., using signals routed through the silicon interposer or TSVs), a higher bandwidth may be achieved between the HBM devices and host device than in conventional systems. In other words, the TSVs interconnecting DRAM dies within an HBM device, and the silicon interposer integrating HBM devices and a host device or the TSVs that extend between a host device and HBM devices stacked thereon, enable the routing of a greater number of signals (e.g., wider data buses) than is typically found between packaged memory devices and a host device (e.g., through a printed circuit board (PCB)). The high-bandwidth interface within a SiP enables large amounts of data to move quickly between the host device (e.g., GPU/CPU/TCU) and HBM devices during operation. For example, the high-bandwidth channels can be on the order of 1000 gigabytes per second (GB/s, sometimes also referred to as gigabits (Gb)). As a result, the SiP device can quickly complete computing operations once data is loaded into the HBM devices. SiP devices, in turn, are typically integrated with a package substrate (e.g., a PCB) adjacent to other electronics and/or other SiP devices within a packaged system.

Market demands on SiP devices and/or the HBM devices therein can present certain challenges, however. One such challenge is that traffic-heavy circuits in HBM devices, such as input/output (“IO”) circuits in an interface die, can generate significant amounts of heat. As described herein, the heat generated by traffic-heavy circuits in HBM devices, such as by the IO circuits, and hot spots localized to those traffic-heavy circuits, can cause deleterious effects on the HBM device.

For example, the DRAM dies of an HBM device are made up of one or more DRAM memory arrays, each of which contains a plurality of memory cells. Each memory cell (representing a single bit of data) is typically implemented with a capacitor, where the capacitor’s charge indicates the bit’s value (e.g., a charged capacitor may indicate a logical value of ‘1’ in the memory cell, and a discharged capacitor may indicate a logical value of ‘0’ in the memory cell). Over time each capacitor’s charge naturally leaks (e.g., a charged capacitor slowly discharges to a discharged state), which can result in data loss. Therefore DRAM-based memories, such as HBM devices, periodically read contents from the DRAM and write the data back to the DRAM, thereby restoring the charge in the corresponding capacitor. This operation is known as a refresh. A host device (and/or memory controller therein) may periodically issue a refresh command that triggers a refresh operation (e.g., a read and write back) of one or more arrays of DRAM.

It has been observed that capacitors in memory cells discharge more quickly when at higher temperatures, and therefore need to be refreshed more frequently than capacitors in memory cells at lower temperatures in order to maintain memory integrity. Some approaches to account for temperature when performing refresh operations are known, but suffer from various shortcomings. For example, as described below, some approaches rely on a single temperature value associated with an HBM device, based on which the refresh rate is set uniformly for the entire HBM device. These approaches, however, fail to account for the fact that temperatures can be uneven within an HBM device (e.g., temperatures are highest at or near hot spots generated by high-traffic circuits), and therefore not all memory cells need to be refreshed at the same rate. Unnecessary refresh operations can increase power consumption without providing meaningful benefits, and can also decrease the total accessibility of the memory cells (e.g., memory cells may not be accessible to the host device during a refresh operation).

The systems and methods described herein address the above-described and other shortcomings by adjusting the rate of refresh operations performed at a memory die based on temperature differences, temperature ratios, and/or the like between a particular memory die and another memory die (e.g., the hottest memory die) in an HBM device. As described herein, HBM devices with localized refresh adjustment modify the rate of refresh operations performed on different memory dies independently based on comparisons between the temperature of an individual memory die and the temperature of another die included in the same HBM device. For example, when an HBM device with localized refresh adjustment receives one or more refresh commands from a host device directed to a particular memory die, the HBM device can determine a modified refresh rate for that particular die based on the temperature of the particular die and/or the temperature of another die in the stack, and filter (e.g., selectively ignore and/or not perform a subset of) the one or more refresh commands. For example, a host device coupled to the HBM device with localized refresh adjustment may generate (and the HBM device can receive) refresh commands at a particular rate for the entire HBM device (i.e., the refresh commands are generated at a rate to perform the same number of refresh operations within a time period for each memory die included in the HBM device), and the HBM device can perform different numbers of refresh operations for different dies depending on the relative temperatures of the different dies. In other words, the host device can issue refresh commands at a default and/or uniform rate, and the HBM device with localized refresh adjustment will perform refresh operations on different memory dies at different rates that are based on the temperature differences among the different memory dies.

As used herein, the terms “vertical,” “lateral,” “upper,” “lower,” “top,” and “bottom” can refer to relative directions or positions of features in the devices in view of the orientation shown in the drawings. For example, “bottom” can refer to a feature positioned closer to the bottom of a page than another feature. These terms, however, should be construed broadly to include devices having other orientations, such as inverted or inclined orientations where top/bottom, over/under, above/below, up/down, and left/right can be interchanged depending on the orientation.

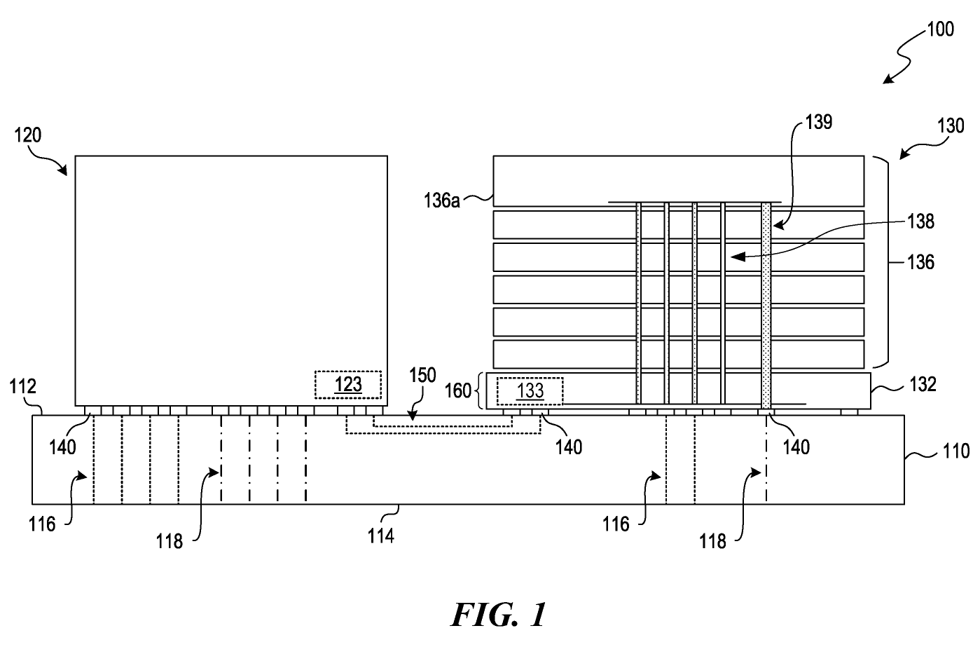

FIG. 1 is a partially schematic cross-sectional diagram of a SiP device 100. As described herein, in some embodiments the SiP device 100 does not provide localized refresh adjustment. As illustrated in FIG. 1, the SiP device 100 includes a base substrate 110 (e.g., a silicon interposer, another organic interposer, an inorganic interposer, and/or any other suitable base substrate), as well as a host device 120 and an HBM device 130 each integrated with (e.g., carried by and coupled to) an upper surface 112 of the base substrate 110 through a plurality of interconnect structures 140 (three labeled in FIG. 1). The interconnect structures 140 can be solder structures (e.g., solder balls), metal-metal bonds, bumps, micro bumps, and/or any other suitable conductive structure that mechanically and electrically couples the base substrate 110 to each of the host device 120 and the HBM device 130. Further, the host device 120 is coupled to the HBM device 130 through one or more communication channels 150 formed in the base substrate 110 (sometimes referred to as a SiP bus). The communication channels 150 can include one or more route lines (two illustrated schematically in FIG. 1) formed into (or on) the base substrate 110.

As further illustrated in FIG. 1, the base substrate 110 includes a plurality of external signal TSVs 116 and a plurality of external power TSVs 118 extending between the upper surface 112 and a lower surface 114 of the base substrate 110. The external signal TSVs 116 can communicate signals (e.g., data, control signals, processing commands, and/or the like) between (i) the host device 120 and/or the HBM device 130 and (ii) an external component (e.g., a PCB that the base substrate 110 is integrated with, an external controller, and/or the like). The external power TSVs 118 can provide electrical power to the host device 120 and/or the HBM device 130 from an external power source.

The host device 120 can include a variety of components, such as a processing unit (e.g., CPU/GPU/TCU), one or more registers, one or more cache memories, and/or a variety of other components (not shown). In the illustrated environment, the host device 120 additionally includes a host input/output (I/O) circuit 123 that can direct signals to and/or from the HBM device 130 through the communication channels 150. Additionally, or alternatively, the host I/O circuit 123 can direct signals to and/or from an external component (e.g., a controller coupled to one or more of the external signal TSVs 116 and/or the like).

The HBM device 130 can include an interface die 132 and a stack of one or more memory dies 136 (six illustrated in FIG. 1) carried by the interface die 132. The HBM device 130 also includes one or more signal TSVs 138 (four illustrated in FIG. 1) and one or more power TSVs 139 (one illustrated in FIG. 1) each extending from the interface die 132 to an uppermost memory die 136a. The signal TSVs 138 can communicate signals (e.g., data, control signals, processing commands, and/or the like) between the interface die 132 and each of the memory dies 136. In particular, the signal TSVs 138 can communicably couple each of the memory dies 136 to an I/O circuit 133 in the interface die 132 (in addition to various other circuits in the interface die 132). As illustrated in FIG. 1, the I/O circuit 133 may be located at and/or near an edge 160 of the interface die 132 that is close to the host device 120 (i.e., the shoreline edge). The power TSV(s) 139 can provide power (e.g., received from one or more of the external power TSVs 118) to the interface die 132 and each of the memory dies 136.

During operation of the SiP device 100, high-traffic circuits, such as the I/O circuit 133, can become hot spots within the HBM device 130. As a result, temperatures can be uneven within the HBM device 130. For example, because the I/O circuit 133 is included in the interface die 132, which is stacked at the very bottom of the HBM device 130, the bottom-most memory die 136 (e.g., the memory die 136 stacked closest to the interface die 132) can be at a higher temperature than the top-most memory die 136 (e.g., the memory die 136 stacked farthest away from the interface die 132). To prevent data loss in each of the memory dies 136, the host device 120 can issue a refresh command to the HBM device 130 (e.g., via the communication channels 150) based on a temperature (e.g., expected or measured) of the hottest memory die 136 (e.g., the worst-case scenario). For example, the SiP device 100 may be configured based on the assumption that the bottom-most memory die 136 will be the hottest memory die 136, and the host device 120 may issue refresh commands to the HBM device 130, instructing the HBM device 130 to perform one or more refresh operations, at a frequency or rate that is based on the expected or measured temperature of the bottom-most memory die 136 (e.g., a predetermined frequency). For example, the HBM device 130 can send a signal (e.g., via communication channels 150) characterizing a worst-case temperature of the HBM device 130, based on which the host device 120 can determine the frequency or rate at which to send refresh commands to the HBM device 130.

In the SiP device 100, each of the memory dies 136 is refreshed at the same frequency according to the rate at which the host device 120 transmits refresh commands to the HBM device 130 (e.g., a refresh rate based on a worst-case temperature of the HBM device 130). Therefore, the memory dies 136 other than the hottest memory die 136 may be refreshed more frequently than necessary. For example, the top-most memory die 136 may be at a lower temperature than the bottom-most die 136, and may therefore only need to be refreshed at 80% the rate at which the bottom-most die 136 needs to be refreshed. These unnecessary refresh operations can increase power consumption of the SiP device 100 without providing meaningful benefits, and can also decrease the total accessibility of the memory cells in the memory dies 136 (e.g., memory cells may not be accessible during a refresh operation). Therefore, it can be advantageous to provide localized refresh adjustment and perform refresh operations at different frequencies for different memory dies 136.

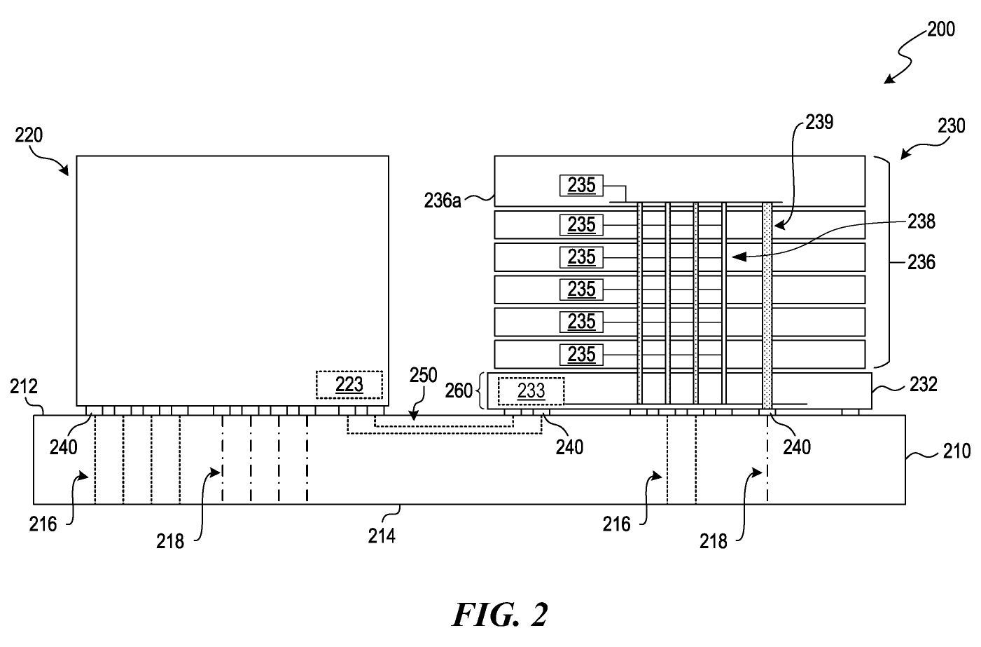

FIG. 2 is a partially schematic cross-sectional diagram of a SiP device 200 configured in accordance with some embodiments of the present technology. The SiP device 200 can generally include many similar components and features as the SiP device 200 of FIG. 1. For example, the SiP device 200 can include a base substrate 210 (e.g., a silicon interposer, another organic interposer, an inorganic interposer, and/or any other suitable base substrate), as well as a host device 220 and an HBM device 230 each integrated with (e.g., carried by and coupled to) an upper surface 212 of the base substrate 210 through a plurality of interconnect structures 240 (three labeled in FIG. 2). The interconnect structures 240 can be solder structures (e.g., solder balls), metal-metal bonds, bumps, micro bumps, and/or any other suitable conductive structure that mechanically and electrically couples the base substrate 210 to each of the host device 220 and the HBM device 230. Further, the host device 220 is coupled to the HBM device 230 through one or more communication channels 250 formed in the base substrate 210 (sometimes referred to as a SiP bus). The communication channels 250 can include one or more route lines (two illustrated schematically in FIG. 2) formed into (or on) the base substrate 210.

As further illustrated in FIG. 2, the base substrate 210 includes a plurality of external signal TSVs 216 and a plurality of external power TSVs 218 extending between the upper surface 212 and a lower surface 214 of the base substrate 210. The external signal TSVs 216 can communicate signals (e.g., data, control signals, processing commands, and/or the like) between (i) the host device 220 and/or the HBM device 230 and (ii) an external component (e.g., a PCB that the base substrate 210 is integrated with, an external controller, and/or the like). The external power TSVs 218 can provide electrical power to the host device 220 and/or the HBM device 230 from an external power source.

The host device 220 can include a variety of components, such as a processing unit (e.g., CPU/GPU/TCU), one or more registers, one or more cache memories, and/or a variety of other components (not shown). In the illustrated environment, the host device 220 additionally includes a host input/output (I/O) circuit 223 that can direct signals to and/or from the HBM device 230 through the communication channels 250. Additionally, or alternatively, the host I/O circuit 223 can direct signals to and/or from an external component (e.g., a controller coupled to one or more of the external signal TSVs 216 and/or the like).

The HBM device 230 can include an interface die 232 and a stack of one or more memory dies 236 (six illustrated in FIG. 2) carried by the interface die 232. Each of the memory dies 236 can include a refresh rate adjustment circuit 235 that, as explained below, provides localized refresh adjustment. The HBM device 230 also includes one or more signal TSVs 238 (four illustrated in FIG. 2) and one or more power TSVs 239 (one illustrated in FIG. 2) each extending from the interface die 232 to an uppermost memory die 236a. The signal TSVs 238 can communicate signals (e.g., data, control signals, processing commands, and/or the like) between the interface die 232 and each of the memory dies 236. In particular, the signal TSVs 238 can communicably couple each of the memory dies 236 to an I/O circuit 233 in the interface die 232 (in addition to various other circuits in the interface die 232). As illustrated in FIG. 2, the I/O circuit 233 may be located at and/or near an edge 260 of the interface die 232 that is close to the host device 220 (i.e., the shoreline edge). The power TSV(s) 239 can provide power (e.g., received from one or more of the external power TSVs 218) to the interface die 232 and each of the memory dies 236.

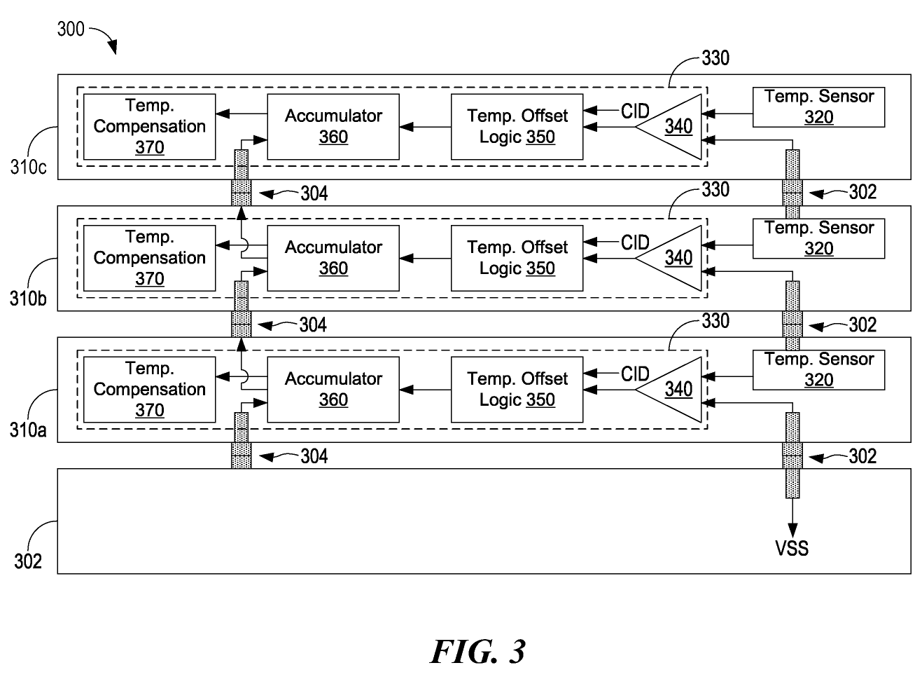

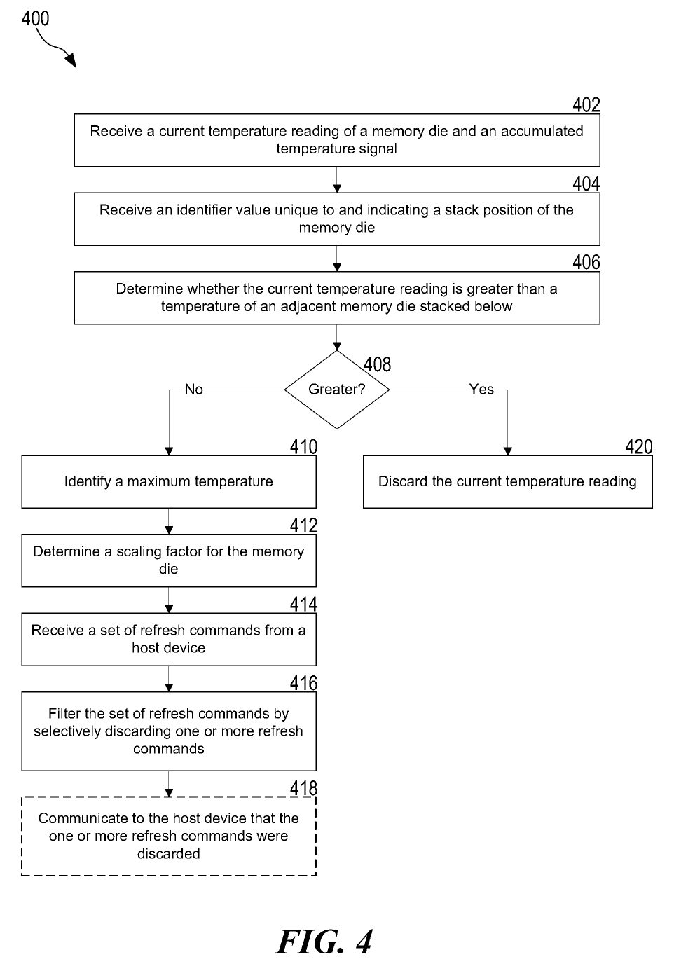

During operation, the refresh rate adjustment circuit 235 of each memory die 236 can determine a scaling factor for the respective memory die 236 based at least in part on a comparison between the temperature of the respective memory die 236 and the temperature of the hottest memory die 236 in the HBM device 230. When the host device 220 issues a set of refresh commands to the HBM device 230, the refresh rate adjustment circuits 235 filter the set of refresh commands to be performed on corresponding memory dies 236 based at least in part on the determined scaling factor. For example, in embodiments in which the set of refresh commands issued by the host device 220 is based on the temperature of the hottest memory die 236, the memory dies 236 other than the hottest memory die 236 may undergo refresh operations at a frequency different from (e.g., lower than) the frequency instructed by the host device 220 per the issued set of refresh commands. Additional details regarding the localized refresh adjustment provided by the refresh rate adjustment circuits 235 are discussed below with reference to FIGS. 3 and 4.

FIG. 2 illustrates a 2.5D SiP device in which the host device 220 and the HBM device 230 are carried by the base substrate 210. Accordingly, embodiments of the present technology are discussed in further detail herein with respect to 2.5D SiP devices. It will be appreciated, however, that embodiments of the present technology can also be configured for use in a 3D SiP in which the HBM device 230 is carried by the host device 220, and may omit the interface die 232.

FIG. 3 is a partially schematic cross-sectional diagram of an HBM device 300 configured in accordance with some embodiments of the present technology. The HBM device 300 can be an example of the HBM device 230 of FIG. 2, and can form part of the SiP device 200 (or other semiconductor device assembly). Certain components of the HBM device 300 (e.g., memory cells, I/O circuits) are omitted to avoid obscuring the illustrated aspects of the present technology.

The HBM device 300 can include an interface die 302, a plurality of memory dies (three are shown in FIG. 3 and individually labeled 310a, 310b, 310c; collectively referred to as “the memory dies 310”), a first set of TSVs 302, and a second set of TSVs 304. The interface die 302 can be operably coupled to a host device (not shown), a first memory die 310a can be carried by (e.g., stacked above) the interface die 302, a second memory die 310b can be carried by (e.g., stacked above) the first memory die 310a, a third memory die 310c can be carried by (e.g., stacked above) the second memory die 310b, and so on. Each of the memory dies 310 can include a temperature sensor 320 and a refresh rate adjustment circuit 330. As shown, each refresh rate adjustment circuit 330 can include a comparator 340, a temperature offset logic circuit 350, an accumulator circuit 360, and a temperature compensation circuit or block 370. Each of the first set of TSVs 302 and the second set of TSVs 304 can be signal TSVs.

The temperature sensor 320 can be configured to generate a current temperature reading that characterizes a temperature of the respective memory die 310. In particular, the temperature sensor 320 can generate a voltage level indicative of the current temperature. The temperature sensor 320 can be a diode-based temperature sensor, a resistive temperature detector, a thermistor, a silicon bandgap temperature sensor, and/or the like. As illustrated, the output of the temperature sensor 320 is provided as an input to the comparator 340 of the respective memory die 310.

The comparator 340 can have (i) a first input coupled to receive the current temperature reading (e.g., a voltage signal) from the temperature sensor 320 of the respective memory die 310 and (ii) a second input coupled to receive, via one of the first set of TSVs 302, either (a) a temperature of another memory die 310 stacked immediately below the respective memory die 310 or (b) a voltage level V_{SS}. For example, in the illustrated embodiment, the comparator 340 of the first memory die 310a has a second input coupled to receive the voltage level V_{SS} (e.g., from the interface die 302), the comparator 340 of the second memory die 310b has a second input coupled to the temperature sensor 320 of the first memory die 310a, the comparator 340 of the third memory die 310c has a second input coupled to the temperature sensor 320 of the second memory die 310b, and so on. The voltage level V_{SS} can be markedly different from the expected voltage levels of the current temperature readings from the temperature sensors 320 so that the refresh rate adjustment circuit 330 of the first memory die 310a can recognize, from the voltage level V_{SS}, that there is no other memory die 310 stacked below. The comparators 340 of the second and third memory dies 310b, 310c can each compare the temperatures of the respective memory die 310 and the memory die 310 stacked immediately below. The comparator 340 generates an output that characterizes the difference in temperature between the corresponding memory die and the memory die beneath (for the comparator in, e.g., memory dies 310b, 310c, and so on), or an output that characterizes the current temperature of the corresponding memory die (for the comparator in memory die 310a).

The temperature offset logic circuit 350 can be operably coupled to the output of comparator 340 of the respective memory die 310 and can be additionally coupled to receive a chip ID (“CID”) or other identifier value unique to a memory die 310 and/or indicating a stack position of the respective memory die 310. Therefore, the temperature offset logic circuit 350 can be configured to (i) receive the output of the corresponding comparator 340 (e.g., a corresponding temperature delta or temperature offset, characterizing the temperature difference between the respective memory die 310 and a memory die underneath) and (ii) receive the CID of the respective memory die 310. In some embodiments, the temperature offset logic circuit 350 can correlate the received comparator output with the received CID. That is, for example, the temperature offset logic circuit 350 of the second memory die 310b can indicate that the temperature offset it received (e.g., from the comparator of the second memory die 310b) is the temperature difference specifically between the second memory die 310b and the first memory die 310a. Further details on example systems and methods for determining the stack position are provided in U.S. Provisional Patent App. No. 63/680,318, titled “APPARATUS INCLUDING STACK TESTING MECHANISM AND ASSOCIATED METHODS,” and filed Aug. 7, 2024, which is incorporated by reference herein in its entirety.

In some embodiments, the temperature offset logic circuits 350 of the second memory die 310b, the third memory die 310c, and so on can each (iii) validate whether the current temperature reading of the respective memory die 310 is good data (e.g., a nonoutlier) based on the received comparator output and the received CID. In some embodiments, the validation is based on the assumption that memory dies positioned higher in the stack will be cooler than memory dies positioned lower in the stack. Therefore, each temperature offset logic circuit 350 (e.g., excluding that of the first memory die 310a) can validate whether the current temperature reading of the respective memory die 310 is lower than the temperature reading of the memory die 310 stacked immediately below. If the current temperature reading is hotter, this can indicate an anomaly in, e.g., the temperature sensor 320 of the respective memory die 310. Accordingly, the current temperature reading can be discarded, and the temperature offset logic circuit 350 may not proceed with the following functions. On the other hand, if the current temperature reading is cooler, aligning with the aforementioned assumption, the temperature offset logic circuit 350 can proceed with the following functions. In some embodiments, the temperature offset generated by a comparator 340 is used without validation.

The temperature offset logic circuits 350 can additionally (iv) provide, to the accumulator circuit 360 of the respective memory die 310, the current temperature reading of the respective memory die 310a, (v) provide, to the accumulator circuit 360 of the respective memory die 310, the output of the corresponding comparator 340, and/or (vi) generate and provide, to the accumulator circuit 360 of the respective memory die 310, a partial refresh adjustment signal. The partial refresh adjustment signal can indicate how many or what percentage of refresh operations can be dropped for the respective memory die 310 based on how much cooler the respective memory die 310 is compared to the die stacked immediately below. As described above, in some embodiment the information provided by the temperature offset logic 350 to the accumulator 360 is conditioned on validation of the information.

The accumulator circuit 360 can be operably coupled to the temperature offset logic circuit 350 of the respective memory die 310 and can receive (i) the current temperature reading, (ii) the output of the corresponding comparator 340 (which may be correlated with the CID) and/or (iii) the partial refresh adjustment signal therefrom. The accumulator circuits 360 of the second memory die 310b, the third memory die 310c, and so on can also each be operably coupled to the accumulator circuit(s) 360 of the memory die(s) 310 stacked below and/or above via the second set of TSVs 304. In operation, the accumulator circuit 360 of the first memory die 310a can communicate to the accumulator circuit 360 of the second memory die 310b a signal that the first memory die 310a is the bottom-most memory die 310. Accordingly, the accumulator circuit 360 of the second memory die 310b can additionally receive (iv) the signal that the first memory die 310a is the bottom-most memory die 310 (e.g., via one of the second set of TSVs 304). The accumulator circuit 360 of the second memory die 310b can then determine the temperature of the first memory die 310a based on the current temperature reading of the second memory die 310b and the temperature offset between the first and second memory dies 310a, 310b. Accordingly, the accumulator circuit 360 of the second memory die 310b can determine the temperature of the first memory die 310a without directly receiving such information. The accumulator circuit 360 of the second memory die 310b can then transmit, to the accumulator circuit 360 of the third memory die 310c, an accumulated temperature signal characterizing temperatures of the first and second memory dies 310a, 310b. For example, the accumulated temperature signal can include the temperature offset between the first and second memory dies 310a, 310b.

The accumulator circuit 360 of the third memory die 310c can receive (i) the current temperature reading of the third memory die 310c (e.g., generated by the corresponding temperature sensor 320), (ii) the temperature offset between the second and third memory dies 310b, 310c from the temperature offset logic circuit 350 of the third memory die 310c, (iii) the partial refresh adjustment signal generated by the temperature offset logic circuit 350 of the third memory die 310c, and (iv) the accumulated temperature signal from the accumulator circuit 360 of the second memory die 310b (e.g., via one of the second set of TSVs 304). The accumulator circuit 360 of the third memory die 310c can then determine (i) the temperature of the second memory die 310b based on the current temperature reading of the third memory die 310c and the temperature offset between the second and third memory dies 310b, 310c, and (ii) the temperature of the first memory die 310a based on the current temperature reading of the third memory die 310c, the temperature offset between the second and third memory dies 310b, 310c, and the temperature offset between the first and second memory dies 310a, 310b (which can be included in the accumulated temperature signal). Accordingly, the accumulator circuit 360 of the third memory die 310c can determine the temperature of each the first and second memory die 310a, 310b without directly receiving such information.

In the manner described above, the accumulator circuits 360 can effectively accumulate temperature offset data and transmit, via the second set of TSVs 304, accumulated temperature signals higher up the stack such that memory dies 310 can each determine its own temperature and the temperatures of the memory dies 310 stacked below. Each accumulator circuit 360 can subsequently transmit the determined temperatures to the temperature compensation block 370 of the respective memory die 310, as well as up the stack of the HBM device 300 to the next memory die 310 and accumulator circuit 360 therein.

The temperature compensation block 370 can be operably coupled to the accumulator circuit 360 of the respective memory die 310 and can be configured to identify the temperature of the hottest memory die 310. For example, the temperature compensation block 370 can identify the maximum temperature value among the temperature of the respective memory die 310 and the temperatures of the memory dies 310 below in the stack. In some embodiments, the HBM device 300 is configured with the assumption that the bottom-most memory die (e.g., the first memory die 310a) will be the hottest memory die and that each subsequent memory die will be at a lower temperature than the memory die stacked immediately below (e.g., due to the increasing distance from the interface die 302, which may be a hot spot of the HBM device 300). Therefore, as long as this assumption holds true, the temperature compensation block 370 of each memory die 310 can determine the maximum temperature (e.g., the temperature of the first memory die 310a) without necessarily receiving information regarding the temperatures of the memory dies 310 stacked above the respective memory die 310. In some embodiments, the refresh rate adjustment circuits 330 can each verify whether this assumption is true. For example, each temperature offset logic circuit 350 can verify whether the current temperature reading of the respective memory die 310 (received from the corresponding temperature sensor 320) is indeed lower than the temperature of the memory die 310 stacked immediately below based on the output of the corresponding comparator 340. Additional details regarding this verification process are discussed below with reference to FIG. 4.

The temperature compensation block 370 can be further configured to determine a scaling factor for the respective memory die 310 based at least in part on a comparison between the current temperature reading of the respective memory die 310 and the identified maximum temperature. In some embodiments, the scaling factor is determined by referencing a lookup table that lists temperature values, temperature differences, temperature ratios, and/or the like, and correlates each to a predetermined scaling factor. For example, the lookup table can include buckets of temperature ranges (e.g., Bucket 1 includes temperatures A–B, Bucket 2 includes temperatures C–D, Bucket 3 includes temperatures E–F, etc.), and each bucket can be associated with a unique scaling factor (e.g., Bucket 1 is associated with a scaling factor of 0.9, Bucket 2 is associated with a scaling factor of 0.8, Bucket 3 is associated with a scaling factor of 0.65, etc.). In some embodiments, the scaling factor can be determined via a formula that uses the current temperature reading and the identified maximum temperature as inputs. The determined scaling factor can represent the minimum proportion of refresh operations (as originally set by a host device) needed to adequately preserve the data stored in the memory die given the temperature of the memory die. In other words, the scaling factor characterizes what percentage or ratio of refresh operations, generated by a host device at a rate or frequency consistent with the identified maximum temperature, should be performed by a memory die having the current temperature in order to retain data at the memory die without performing unnecessary refresh operations. As one example, the scaling factor for a particular memory die that is 10°C cooler than the hottest memory die in the same stack may be set to 0.5 by the refresh rate adjustment circuit 330, such that the particular memory die is refreshed at half the rate that the hottest memory die is refreshed (e.g., the cooler memory die omits on average one out of every two received refresh commands).

During operation of the HBM device 300, the refresh rate adjustment circuit 330 can receive a set of refresh commands from a host device (e.g., the host device 220 of FIG. 2) operably coupled to the HBM device 300. The set of refresh commands from the host device can instruct the HBM device 300 to perform refresh operations on each of the memory dies 310 uniformly at a predetermined frequency. Since the memory die 310 with the highest temperature represents the worst-case scenario (e.g., expected to lose data the quickest), the predetermined frequency can be based at least in part on the maximum temperature among the memory dies 310 to ensure that each memory die 310 is refreshed at a sufficient rate. For example, if the data stored in the hottest memory die can be preserved by refreshing the hottest memory die at a refresh rate of x, then the data stored in any cooler memory die can also be preserved by refreshing that memory die at the refresh rate of x, although, as explained herein, refreshing that cooler memory die at a refresh rate less than x may also be sufficient.

Subsequently, the temperature compensation block 370 can filter the set of refresh commands by selectively discarding one or more refresh commands of the set of refresh commands based at least in part on the determined scaling factor. For example, if the determined scaling factor for the second memory die 310b is 0.85 and the determined scaling factor for the third memory die 310c is 0.6, 15% of the refresh operations can be ignored or discarded for the second memory die 310b such that the second memory die 310b is refreshed at only 85% of the rate set by the host device, and 40% of the refresh operations can be ignored or discarded for the third memory die 310c such that the third memory die 310c is refreshed at only 60% of the rate set by the host device. The first memory die 310a, which is expected to be the hottest memory die 310, can be refreshed at the rate set by the host device (e.g., the determined scaling factor for the first memory die 310a can be 1, resulting in no refresh rate adjustment).

Accordingly, memory dies 310 at higher temperatures can be refreshed at a higher rate than memory dies 310 at lower temperatures. This localized refresh adjustment can decrease the total number of refresh operations performed in the HBM device 300 without losing data stored therein. As discussed elsewhere herein, memory cells lose data more slowly at lower temperatures, so cooler memory dies can be refreshed at a relatively lower frequency. Decreasing the total number of refresh operations performed is expected to decrease the overall power consumption of the HBM device 300. In some embodiments, the HBM device 300 can also communicate to the host device that select memory dies 310 are being refreshed at a lower rate than issued by the host device, and are therefore accessible for additional periods of time (e.g., since memory cells are generally inaccessible by the host device during a refresh operation). Accordingly, decreasing the total number of refresh operations performed is also expected to make the memory dies 310 more accessible for the host device, which can lead to faster processing speeds, and/or the like.

It is appreciated that the various components of the refresh rate adjustment circuit 330 illustrated in FIG. 3 merely represent one possible configuration of the refresh rate adjustment circuit 330, and that the refresh rate adjustment circuit 330 can include additional, fewer, and/or alternative components. For example, in some embodiments, the functions of the refresh rate adjustment circuit 330, described herein, can be performed by a single circuit. Accordingly, one of ordinary skill in the art will understand that embodiments of the present technology are not limited to any specific component of the refresh rate adjustment circuit 330 (e.g., the temperature offset logic circuit 350, the accumulator circuit 360) performing any specific function. Moreover, in some embodiments, the accumulated temperature signal can include the actual temperatures of the memory dies 310, as opposed to merely the temperature offsets.

FIG. 4 is a flowchart illustrating a method 400 for adjusting a refresh rate of a memory die in a stack of memory dies in accordance with some embodiments of the present technology. While the steps of the method 400 are described below in a particular order, one or more of the steps can be performed in a different order or omitted, and the method 400 can include additional and/or alternative steps. In some embodiments, the method 400 is performed by the refresh rate adjustment circuit 330 of FIG. 3. Additionally, although the method 400 may be described below with reference to the embodiments of the present technology described herein, the method 400 can be performed with other embodiments of the present technology.

The method 400 begins at block 402 by receiving a current temperature reading of a memory die (e.g., one of the memory dies 310) and an accumulated temperature signal. The current temperature reading can be received from a temperature sensor (e.g., the temperature sensor 320) included in the respective memory die. The accumulated temperature signal can include temperature offsets between adjacent memory dies or other values that characterize the temperatures of one or more other memory dies in the stack of memory dies. The accumulated temperature signal can be received from another (e.g., adjacent) memory die.

At block 404, the method 400 continues by receiving an identifier value unique to and indicating a stack position of the memory die. For example, the temperature offset logic circuit 350 can receive the CID as discussed above with reference to FIG. 3. Accordingly, in some embodiments, the temperature offsets, the current temperature readings, and/or the like can be paired with the stack position(s) of the corresponding memory die(s).

At block 406, the method 400 continues by determining whether the current temperature reading is greater than a temperature of an adjacent memory die stacked below. For example, the temperature offset logic circuit 350 (FIG. 3) can use the output of the corresponding comparator 340 (FIG. 3) to determine whether the respective memory die is hotter or colder than the memory die stacked immediately below. As previously mentioned, in some embodiments, the devices are configured with the assumption that memory dies positioned higher in the stack will be cooler than memory dies positioned lower in the stack. Therefore, block 406 provides a method for verifying whether this assumption actually holds true in the given HBM device.

In the event that the current temperature reading of the respective memory die is not greater than the temperature of the adjacent memory die stacked below, corresponding to “No” from decision block 408, this can indicate that the particular memory die positioned higher in the stack is colder than the memory die positioned lower in the stack, as expected, and can proceed with localized refresh adjustment. Accordingly, the method 400 continues at block 410 by identifying a maximum temperature. In some embodiments, the maximum temperature is identified based at least in part on the current temperature reading of the respective memory die and the accumulated temperature signal received at block 402. For example, if the accumulated temperature signal includes one or more temperature offsets, the maximum temperature can be identified by first determining the temperature of individual ones of the memory dies, then finding the maximum among them.

At block 412, the method 400 continues by determining a scaling factor for the respective memory die. In some embodiments, the scaling factor is determined by referencing a lookup table that lists temperature values, temperature differences, temperature ratios, and/or the like, and correlates each to a predetermined scaling factor. In some embodiments, the scaling factor can be determined via a formula that uses the current temperature reading and the identified maximum temperature as inputs. Other methodologies of determining the scaling factor are within the scope of the present technology. The determined scaling factor can represent the minimum proportion of refresh operations (as originally set by a host device) needed to adequately preserve the data stored in the memory die given the temperature of the memory die. For example, the scaling factor can be set such that between 1–99%, 10–90%, 30–70%, 40–60%, 10–50%, 50–90%, or other portion of the set of refresh commands is discarded.

At block 414, the method 400 continues by receiving a set of refresh commands from a host device. The set of refresh commands can instruct the HBM device to perform refresh operations on each of the memory dies at a predetermined frequency that is based on the highest temperature among the memory dies (e.g., the worst-case scenario).

At block 416, the method 400 continues by filtering the set of refresh commands by selectively discarding one or more refresh commands of the set of refresh commands based at least in part on the determined scaling factor. In some embodiments, the determined scaling factor for the hottest memory die (e.g., the bottom-most memory die) is 1, and the determined scaling factor for each of the remaining memory dies is less than 1 (e.g., 0.9, 0.63, 0.47). Accordingly, the hottest memory die can be refreshed at the rate originally set by the host device, while the remaining memory dies can be refreshed at a lower rate to account for their lower temperatures, and consequently not needing as many refresh operations to preserve data stored therein.

In some embodiments, at block 418, the method 400 continues by communicating to the host device that the one or more refresh command were discarded for select ones of the memory dies. Doing so effectively communicates to the host device that the select ones of the memory dies remain accessible during time periods in which the host device originally intended the memory dies to be undergoing refresh operations, and thus inaccessible, but in which the select ones of the memory dies are not undergoing refresh operations, and thus accessible. Increasing the overall accessibility of the memory dies can increase operation speeds of the SiP device or other device that the HBM device is included in.

Returning to decision block 408, in the event that the current temperature reading of the respective memory die is greater than the temperature of the adjacent memory die stacked below, corresponding to “Yes” from decision block 408, this can indicate that the memory die positioned higher in the stack is hotter than the memory die positioned lower in the stack. This may contradict the previously mentioned assumption, since if an interface die (e.g., the interface die 302 of FIG. 3) is indeed a hot spot of the HBM device, memory dies positioned lower in the stack (e.g., closer to the interface die) are expected to be hotter than memory dies positioned higher in the stack due to the different distances between the hot spot and the particular memory die. Accordingly, this can represent an error condition (e.g., that the temperature reading in inaccurate or otherwise unreliable), and the method 400 continues at block 420 by discarding the current temperature reading. In such cases, the particular memory die with the error condition may not undergo localized refresh adjustment (e.g., can be refreshed at the refresh rate intended by the host device). Also, the remaining memory dies (assuming they do not have such error conditions) can proceed with block 410 to undergo localized refresh adjustment, but exclude the temperature of the memory die with the error condition when identifying the maximum temperature (e.g., the problematic temperature can be discarded prior to the maximum temperature being identified).

Referring to FIGS. 2–4 together, embodiments of the present technology are expected to provide localized refresh adjustment and thereby provide improved operational characteristics compared to, e.g., memory devices without localized refresh adjustment. For example, the HBM devices disclosed herein provide reduced power consumption by leveraging the fact that there is temperature variation among memory dies in the same stack and the fact that memory dies require different refresh rates depending on the temperatures thereof. More specifically, when a host device issues a refresh command instructing an HBM device to perform refresh operations at some frequency in a uniform manner across the memory dies in the stack, an HBM device configured in accordance with embodiments of the present technology selectively discards or ignores a portion of the refresh command. In other words, the HBM device performs only a subset of the refresh operations originally intended by the host device for select ones of the memory devices depending on their temperatures. This results in a smaller total number of refresh operations performed by the HBM device, which directly reduces the total power consumption of the HBM device. Furthermore, in embodiments in which the HBM device communicates to the host device that certain refresh operations were not performed for select ones of the memory dies, the host device becomes aware of and is able to access the data stored in those memory dies. In particular, the host device can access those memory dies during times that those memory dies would have otherwise been inaccessible due to undergoing refresh operations at the rate intended by the host device, thus increasing the overall accessibility of the HBM device.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately,” “generally,” and/or “about” are used herein to mean within at least 10% of a given value or limit. Purely by way of example, an approximate ratio means within 10% of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A high-bandwidth memory (HBM) device, comprising:
a plurality of memory dies, each memory die comprising:
an array of memory cells;
a temperature sensor configured to generate a current temperature reading that characterizes a temperature of the respective memory die; and
a refresh rate adjustment circuit operably coupled to the array of memory cells and the temperature sensor, wherein the refresh rate adjustment circuit is configured to:
receive the current temperature reading from the temperature sensor;
receive an accumulated temperature signal characterizing temperatures of one or more other memory dies;
identify a maximum temperature based on the current temperature reading and the accumulated temperature signal;
determine, based at least in part on a comparison between the current temperature reading and the identified maximum temperature, a scaling factor for the respective memory die;
receive a set of refresh commands from a host device operably coupled to the HBM device, wherein the received set of refresh commands is based at least in part on the maximum temperature; and
filter the set of refresh commands by selectively discarding one or more refresh commands of the set of refresh commands based at least in part on the determined scaling factor; and
a plurality of through-silicon vias (TSVs), wherein individual ones of the TSVs are configured to operably couple the refresh rate adjustment circuits of adjacent ones of the plurality of memory dies to one another such that the refresh rate adjustment circuit can receive the accumulated temperature signal.

2. The HBM device of claim 1, wherein the refresh rate adjustment circuit comprises:
a comparator having a first input coupled to receive the current temperature reading and a second input coupled to receive a temperature of another memory die of the plurality of memory dies stacked immediately below the respective memory die, wherein the comparator is configured to generate a temperature offset between the temperatures received at the first input and the second input; and
a temperature offset logic circuit operably coupled to the comparator and configured to (i) receive the temperature offset from the comparator and (ii) verify, based on the temperature offset and the current temperature reading, that the current temperature reading is lower than the temperature of the another memory die,
wherein the HBM device further comprises a second plurality of TSVs, wherein the second TSVs are each configured to operably couple the comparator of one of the plurality of memory dies to the temperature sensor of another memory die of the plurality of memory dies stacked immediately below the respective memory die.

3. The HBM device of claim 2, wherein the refresh rate adjustment circuit further comprises:
an accumulator circuit operably coupled to the temperature offset logic circuit and configured to generate and communicate, to accumulator circuits included in other memory dies of the plurality of memory dies via the plurality of TSVs, the accumulated temperature signal; and
a temperature compensation block operably coupled to the accumulator circuit and configured to:
identify the maximum temperature based on the current temperature reading and the accumulated temperature signal;
determine the scaling factor for the respective memory die;
receive the set of refresh commands from the host device; and
filter the set of refresh commands.

4. The HBM device of claim 1, wherein the HBM device is configured to communicate to the host device that the one or more refresh commands of the set of refresh commands were discarded.

5. The HBM device of claim 1, wherein the refresh rate adjustment circuit of at least one of the plurality of memory dies is further configured to:
receive an identifier value unique to and indicating a stack position of the respective memory die;
determine, based at least in part on the current temperature reading, the accumulated temperature signal, and the identifier value, that the current temperature reading is greater than a temperature of an adjacent memory die stacked below the respective memory die; and
discard, prior to identifying the maximum temperature, the current temperature reading.

6. The HBM device of claim 1, wherein the refresh rate adjustment circuit is configured to determine the scaling factor by (i) referencing a lookup table that correlates a plurality of temperature comparisons to a plurality of predetermined scaling factors and (ii) selecting the scaling factor among the plurality of predetermined scaling factors based at least in part on the comparison between the current temperature reading and the identified maximum temperature.

7. The HBM device of claim 1, wherein the refresh rate adjustment circuit is configured to filter the set of refresh commands by discarding between 10–50% of the set of refresh commands.

8. The HBM device of claim 1, wherein the refresh rate adjustment circuit is configured to filter the set of refresh commands by discarding between 50–90% of the set of refresh commands.

9. A method for adjusting a refresh rate of a memory die in a stack of memory dies, the method comprising:
receiving a current temperature reading of the memory die and an accumulated temperature signal characterizing temperatures of one or more other memory dies in the stack of memory dies;
identifying a maximum temperature based on the current temperature reading and the accumulated temperature signal;
determining, based at least in part on a comparison between the current temperature reading and the identified maximum temperature, a scaling factor for the memory die;
receiving a set of refresh commands from a host device operably coupled to the stack of memory dies, wherein the received set of refresh commands is based at least in part on the maximum temperature; and
filtering the set of refresh commands by selectively discarding one or more refresh commands of the set of refresh commands based at least in part on the determined scaling factor.

10. The method of claim 9, further comprising communicating to the host device that the one or more refresh commands of the set of refresh commands were discarded.

11. The method of claim 9, wherein determining the scaling factor comprises:
referencing a lookup table that correlates a plurality of temperature comparisons to a plurality of predetermined scaling factors; and
selecting the scaling factor among the plurality of predetermined scaling factors based at least in part on the comparison between the current temperature reading of the and the identified maximum temperature.

12. The method of claim 9, wherein filtering the set of refresh commands comprises discarding between 10–50% of the set of refresh commands.

13. The method of claim 9, wherein filtering the set of refresh commands comprises discarding between 50–90% of the set of refresh commands.

14. The method of claim 9, further comprising:
receiving an identifier value unique to and indicating a stack position of the memory die; and
determining, based at least in part on the received current temperature reading, the received accumulated temperature signal, and the received identifier value, that the current temperature reading is less than a temperature of an adjacent memory die stacked below the memory die in the stack of memory dies.

15. A memory die included in a stack of memory dies, the memory die comprising:
an array of memory cells;
a temperature sensor configured to generate a current temperature reading of the memory die; and
a refresh rate adjustment circuit operably coupled to the array of memory cells and the temperature sensor, wherein the refresh rate adjustment circuit is configured to:
receive the current temperature reading from the temperature sensor,
receive an accumulated temperature signal characterizing temperatures of one or more other memory dies from temperature sensors of the one or more other memory dies,
identify a maximum temperature based on the current temperature reading and the accumulated temperature signal,
determine, based at least in part on a comparison between the current temperature reading and the identified maximum temperature, a scaling factor for the memory die,
receive a set of refresh commands from a host device operably coupled to the memory die, wherein the received set of refresh commands is based at least in part on the maximum temperature, and
filter the set of refresh commands by selectively discarding one or more refresh commands of the set of refresh commands based at least in part on the determined scaling factor.

16. The memory die of claim 15, wherein the refresh rate adjustment circuit includes:
a comparator having a first input coupled to receive the current temperature reading a second input coupled to receive a temperature of another memory die stacked immediately below the memory die, wherein the comparator is configured to generate a temperature offset between the temperatures received at the first input and the second input;
a temperature offset logic circuit operably coupled to the comparator and configured to (i) receive the temperature offset from the comparator and (ii) verify, based on the temperature offset and the current temperature reading, that the current temperature reading is lower than the temperature of the another memory die;
an accumulator circuit operably coupled to the temperature offset logic circuit and configured to generate and communicate, to accumulator circuits included in other memory dies, the accumulated temperature signal; and
a temperature compensation block operably coupled to the accumulator circuit and configured to:
identify the maximum temperature based on the current temperature reading and the accumulated temperature signal;
determine the scaling factor for the memory die;
receive the set of refresh commands from the host device; and
filter the set of refresh commands.

17. The memory die of claim 15, wherein the memory die is included in a high-bandwidth memory (HBM) device configured to communicate to the host device that the one or more refresh commands of the set of refresh commands were discarded.

18. The memory die of claim 15, wherein the refresh rate adjustment circuit is further configured to:
receive an identifier value unique to and indicating a stack position of the memory die;
determine, based at least in part on the current temperature reading, the accumulated temperature signal, and the identifier value, that the current temperature reading is greater than a temperature of an adjacent memory die stacked below the memory die; and
discard, prior to identifying the maximum temperature, the current temperature reading.

19. The memory die of claim 15, wherein the refresh rate adjustment circuit is configured to determine the scaling factor by (i) referencing a lookup table that correlates a plurality of temperature comparisons to a plurality of predetermined scaling factors and (ii) selecting the scaling factor among the plurality of predetermined scaling factors based at least in part on the comparison between the current temperature reading and the identified maximum temperature.

20. The memory die of claim 15, wherein the refresh rate adjustment circuit is configured to filter the set of refresh commands by discarding between 30–70% of the set of refresh commands.
